(19) United States
(12) Patent Application Publication
(10) Pub. No.: US 2015/0003266 A1
(43) Pub. Date: Jan. 1, 2015

(54) METHOD AND APPARATUS FOR HANDLING A CONFIGURATION FOR MEASUREMENT IN A WIRELESS COMMUNICATION SYSTEM

(71) Applicant: INNOVATIVE SONIC CORPORATION, Taipei City (TW)

(72) Inventor: Yu-Hsuan Guo, Taipei City (TW)

(21) Appl. No.: 14/320,004

(22) Filed: Jun. 30, 2014

Related U.S. Application Data
(60) Provisional application No. 61/841,553, filed on Jul. 1, 2013.

(51) Int. Cl. H04W 36/00; H04W 72/02; H04W 24/10

(52) U.S. Cl. CPC H04W 36/0088; H04W 24/10; H04W 72/02
USPC 370/252

(57) ABSTRACT

Methods and apparatuses are disclosed for handling a configuration for measurement by a User Equipment (UE) in a wireless communication system. The method includes connecting to a serving cell. The method further includes receiving a first signaling that includes a measurement configuration. The method also includes applying the measurement configuration upon receiving a second signaling indicating to start performing measurement.

### CROSS-REFERENCE TO RELATED APPLICATIONS

The present Application claims the benefit of U.S. Provisional Patent Application Ser. No. 61/841,553 filed on Jul. 1, 2013, the entire disclosure of which is incorporated herein by reference.

### FIELD

This disclosure generally relates to wireless communication networks, and more particularly, to methods and apparatuses for handling a configuration for measurement in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure for which standardization is currently taking place is an Evolved Universal Terrestrial Radio Access Network (E-UTRAN). The E-UTRAN system can provide high data throughput in order to realize the above-noted voice over IP and multimedia services. The E-UTRAN system's standardization work is currently being performed by the 3GPP standards organization. Accordingly, changes to the current body of 3GPP standard are currently being submitted and considered to evolve and finalize the 3GPP standard.

### SUMMARY

Methods and apparatuses are disclosed for handling a configuration for measurement by a User Equipment (UE) in a wireless communication system. The method includes connecting to a serving cell. The method further includes receiving a first signaling that includes a measurement configuration. The method also includes applying the measurement configuration upon receiving a second signaling indicating to start performing measurement.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a diagram of a reference scenario for a high speed train as shown in 3GPP RP-130896, “3GPP TR 36.836 V12.0.0 Mobile Relay for E-UTRA”.

FIG. 6 is a flow diagram of one exemplary method.

FIG. 7 is a flow diagram of one exemplary method.

FIG. 8 is a flow diagram of one exemplary method.

FIG. 9 is a flow diagram of one exemplary method.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, or some other modulation techniques.

In particular, the exemplary wireless communication systems devices described below may be designed to support one or more standards such as the standard offered by a consortium named “3rd Generation Partnership Project” referred to herein as 3GPP, including Document Nos. TS 36.300 V11.5.0, entitled “E-UTRA and E-UTRAN, Overall description, Stage 2”; TS 36.331 V11.3.0, entitled “E-UTRA RRC protocol specification”; RP-122010, entitled “Update of SID on Mobile Relay for E-UTRA”; RP-130896, entitled “3GPP TR 36.836 V12.0.0 Mobile Relay for E-UTRA”; TS 36.304 V11.3.0, entitled “E-UTRA UE procedures in idle mode”; and TS 36.321 V11.2.0, entitled “E-UTRA MAC protocol specification”. The standards and documents listed above are hereby expressly incorporated by reference in their entirety.

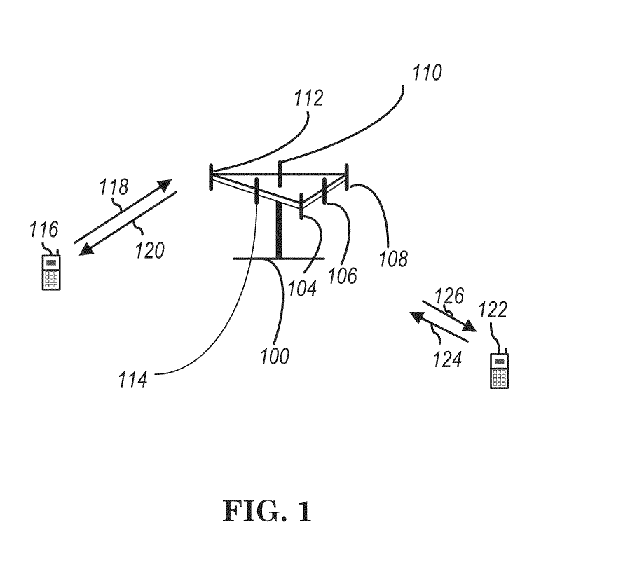

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), or some other terminology. An access terminal (AT) may also be called user equipment (UE), a wireless communication device, terminal, access terminal or some other terminology.

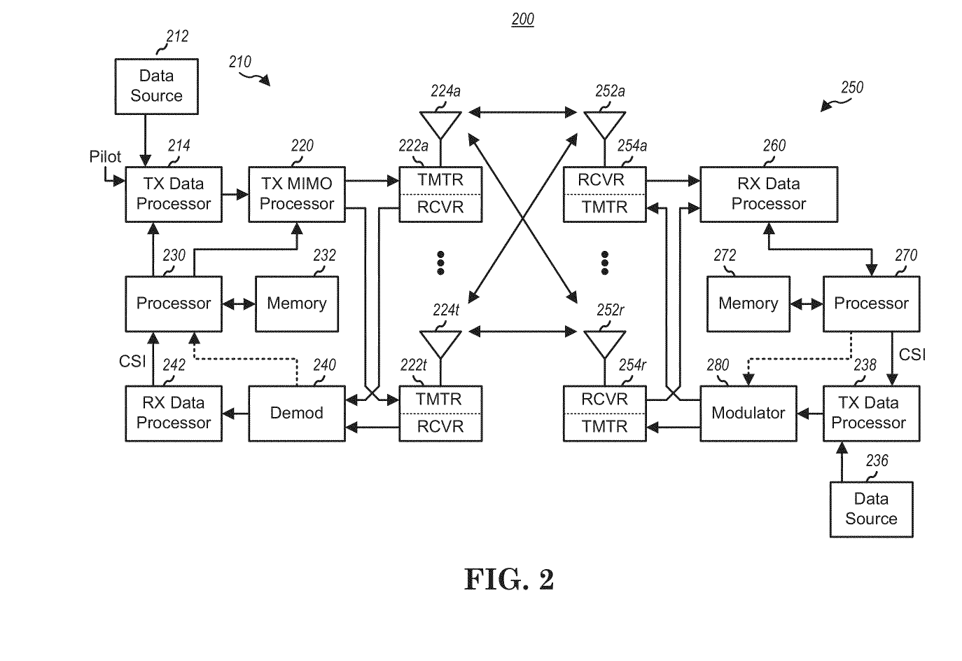

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

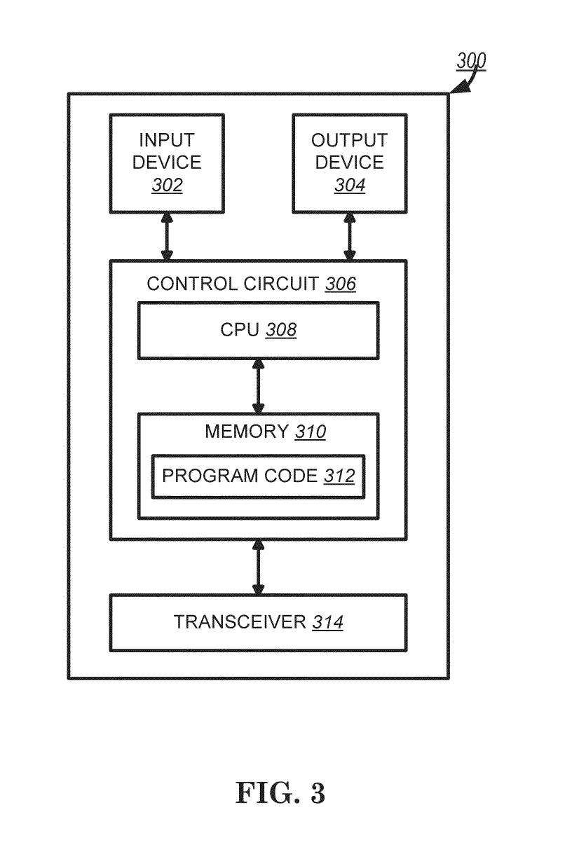

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the LTE system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

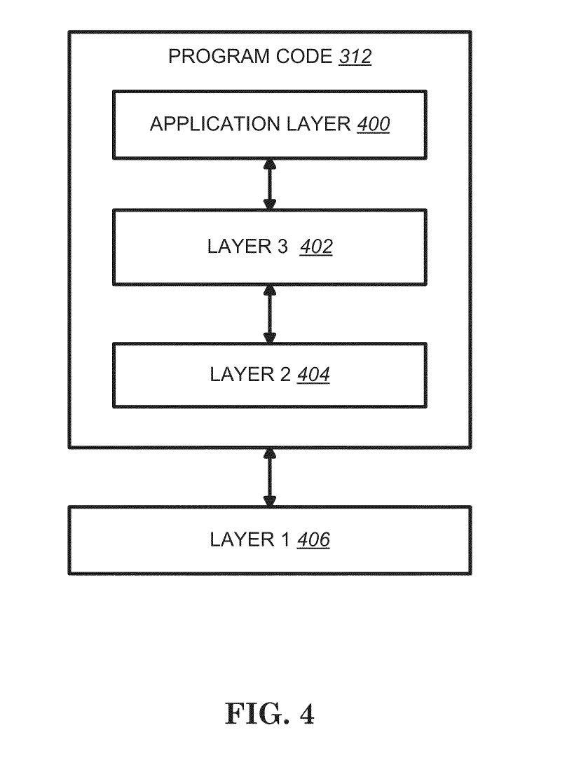

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE or LTE-A systems, the Layer 2 portion may include a Radio Link Control (RLC) layer and a Medium Access Control (MAC) layer. The Layer 3 portion may include a Radio Resource Control (RRC) layer.

Currently, LTE only supports stationary relay, the details of which are described in 3GPP TS 36.300 V11.5.0 and TS 36.331 V11.3.0. As for mobile relay, the study item on mobile relay for E-UTRA (RP-122010) is terminated and a corresponding work item may be initiated in the next RAN plenary meeting. The latest technical report corresponding to the study item is provided in RP-130896. In part, RP-130896 describes the target scenario to study as follows:

### 4.1 Scenario

High speed public transportation is being deployed worldwide at an increased pace. Hence, providing multiple services of good quality to users on high speed vehicles is important yet more challenging than typical mobile wireless environments.

The mobile relay SI focuses on the high speed train scenario as the target deployment scenario to study. High speed train scenario can be characterized as:
The trains operated with high speed, e.g. 350 km/h
Known trajectory
High penetration loss of the radio signal through the well shield carriages
UEs on the trains are stationary or move at pedestrian speed w.r.t. relay nodes

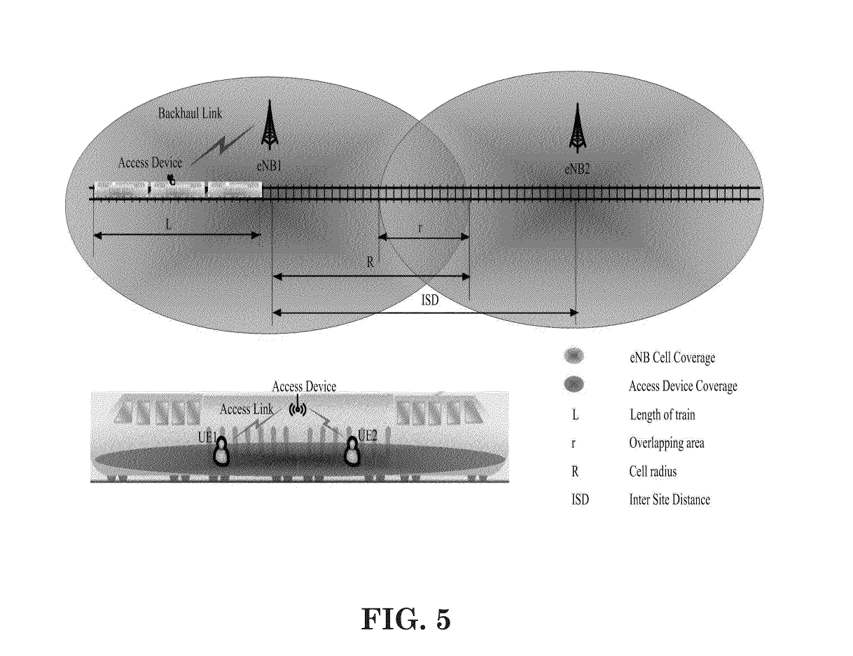

A reference scenario for high speed train is depicted in FIG. 5.

The TGV Eurostar in Europe is 393 m long, moves at speed reaching 300 km/h. The Shinkansen in Japan has similar characteristics, with 480 m long, 300 km/h of commercial speed. The high speed train in China is 432 m long moving at speed reaching 350 km/h. Due to fast moving and well shield carriage, the network in high speed train scenario faces severe Doppler frequency shift and high penetration loss, reduced handover success rate and increased power consumption of UEs.

To improve the coverage of the train deployment, access devices can be mounted on the high speed train, providing a wireless backhaul connection via the eNBs along the railway by outer antenna e.g. installed on top of the train, and wireless connectivity to the UEs inside carriages by inner antenna installed inside.

Also, RP-130896 describes mobile relay as quoted below:

5.2 Mobile relay

The mobile relays are base stations/access points mounted on the high speed trains. The mobile relay is connected wirelessly to Donor eNB (DeNB) via the Un radio interface. The mobile relay provides wireless connectivity service to end users inside the vehicle. In addition to the eNB functionality, mobile relays support a subset of the UE functionality to connect to the DeNB.

5.2.1 Functions

From a specification point of view, functionalities defined for fixed relays in Rel-10 also apply to mobile relays, unless explicitly specified. Due to the mobility of the Mobile Relay, further enhancements or new procedures may be required in order to support all existing network functionalities.

Mobile relays may support multi-RAT functionalities. This means an LTE Un provides the backhaul link, while different air interface technologies, e.g. LTE/3G/2G/WiFi, may be supported on the access link.

Mobile relays continue to provide uninterrupted connectivity for the user plane and control plane of the served UEs to their respective core network nodes, when the Un connection is changed to different DeNBs as the mobile relay moves through the coverage of the network.

Additionally, possible mobile relay architectures are also provided in RP-130896.

Since the target scenario of mobile relay is high speed train scenario, passengers would not get off the train until arriving train stations. In other words, UEs in the train would not leave the coverage of the mobile relay until arriving train stations. And the cell of the mobile relay may be the best cell for the UEs when the train is moving. Accordingly, when the train is in motion, it would appear that performing measurement for mobility purpose, e.g. handover or cell reselection, by the UEs in the train would be unnecessary and would result in unnecessary UE power consumption.

For a UE in RRC_CONNECTED, a UE in a train may need to handover only when the train arrives at a train station. A mobile relay could configure UEs connecting to the mobile relay with a measurement configuration (as disclosed in 3GPP TS 36.331 V11.3.0) when the mobile relay stops or almost stops moving. For example, configuring the measurement configuration may occur when the speed of the mobile relay is less than a threshold. Alternatively, configuring the measurement configuration may occur when the mobile relay arrives at or is close to a specific location, e.g., a train station.

Then, the mobile relay could release the measurement configuration of the UEs when the mobile relay starts moving. For example, the release of the measurement configuration may occur when the speed of the mobile relay is larger than a threshold. Alternatively, the release of the measurement configuration may occur when the mobile relay departs from or is far from a specific location, e.g., the train station.

However, the methods mentioned above would result in a large amount of signaling, e.g., RRC connection reconfiguration procedures (as disclosed in 3GPP TS 36.331 V11.3.0), within a short period when the mobile relay stops or almost stops moving. The large amount of signaling may be attributable to the mobile relay not knowing which UE may be leaving the coverage of the mobile relay. So, all UEs connecting to the mobile relay need to be configured with a measurement configuration to help the mobile relay make handover decisions. However, configuring the UEs with measurement configuration too early would also result in too much power consumption.

Hence, alternative methods are proposed and contemplated herein. In one embodiment, a signaling is used to indicate to a UE to start or stop performing a measurement configuration. The signaling can be a broadcast signaling such as, but not limited to, system information (as disclosed in 3GPP TS 36.331 V.11.3.0), a paging message (as disclosed in 3GPP TS 36.331 V.11.3.0), a PDCCH signaling, or a MAC control element (as disclosed in 3GPP TS 36.321 V.11.2.0). The measurement is used to measure a serving cell, an intra-frequency cell, an inter-frequency cell, or an inter-RAT cell. The signaling may further indicate a time period to perform or not perform the measurement. Alternatively, a signaling providing a measurement configuration may include an indication. The indication is used to indicate to a UE whether to apply the measurement configuration.

For a UE in RRC_IDLE, the UE in a train may need cell reselection only when the train arrives at a train station. A mobile relay could broadcast system information for cell reselection (as disclosed in 3GPP TS 36.331 V11.3.0) when the mobile relay stops or almost stops moving. The system information that may be broadcasted includes, but is not limited to, SystemInformationBlockType3, SystemInformationBlockType4, SystemInformationBlockType5, SystemInformationBlockType6, SystemInformationBlockType7, and/or SystemInformationBlockType8. This system information may be broadcasted when the speed of the mobile relay is less than a predetermined threshold. Alternatively, the system information may be broadcasted when the mobile relay arrives at or is close to a specific location, e.g. a train station.

The mobile relay could stop broadcasting system information for cell reselection when the mobile relay starts moving. The triggering event for stopping the broadcast of the system information may be the speed of the mobile relay being larger than a threshold. Alternatively, the triggering event to stop the broadcast of the system information could be a predetermined distance of the mobile relay and a specific location, e.g. a train station.

However, the UE needs a period of time to acquire the new system information for cell reselection such as, but not limited to, wait for paging occasion (as disclosed in 3GPP TS 36.304 V11.3.0), BCCH modification period (as disclosed in 3GPP TS 36.331V11.3.0), system information scheduling (as disclosed in 3GPP TS 36.331 V11.3.0), or the like. Moreover, UEs in RRC_CONNECTED would also be affected, e.g. consume additional power, as a result of the reception of a paging message indicating system information change.

Hence, alternative methods are proposed and contemplated herein. In one embodiment, a signaling is used to indicate to a UE to start or stop performing cell reselection evaluation. The signaling can be a broadcast signaling such as, but not limited to, a paging message, a PDCCH signaling, or a MAC control element. The cell reselection evaluation would measure an intra-frequency cell, an inter-frequency cell, or an inter-RAT frequency to decide whether to reselect another cell to camp on. The signaling may further indicate a time period to perform or not perform the cell reselection evaluation. Alternatively, a signaling providing cell reselection configuration may include an indication. The indication is used to indicate to a UE whether to apply the cell reselection configuration to perform cell reselection evaluation.

In one exemplary method, a UE connects to a serving cell. The UE receives a first signaling that includes a measurement configuration. The measurement configuration is applied by the UE upon the receipt of a second signaling indicating to start performing measurement. In another method, the UE stops applying the measurement configuration upon a third signaling indicating to stop performing measurement is received. In these methods, the UE does not leave RRC_CONNECTED (as disclosed in 3GPP TS 36.331 V11.3.0) due to the second signaling or the third signaling.

In another exemplary method, a UE connects to a serving cell. The UE receives a first signaling that includes a measurement configuration. The first signaling also includes an indication whether the measurement configuration should be applied by the UE. In one embodiment, the presence of the indication with the first signaling indicates that the measurement configuration should not be applied, and the absence of the indication with the first signaling indicates that the measurement configuration should be applied upon the reception of the first signaling. Alternatively, in another embodiment, the presence of the indication with the first signaling indicates that the measurement configuration should be applied upon the reception of the first signaling, and the absence of the indication with the first signaling indicates that the measurement configuration should not be applied.

In another exemplary method, a network node sends a first signaling that includes a measurement configuration to a UE. The network node also sends a second signaling to indicate to the UE to apply the measurement configuration. In another method, a third signaling is sent to the UE to indicate to the UE to stop applying the measurement configuration. In these methods, the UE does not leave RRC_CONNECTED due to the second signaling or the third signaling.

In another method, a network node sends a first signaling that includes a measurement configuration to a UE. The first signaling also includes an indication whether the measurement configuration should be applied by the UE. In one embodiment, the presence of the indication with the first signaling indicates that the measurement configuration should not be applied, and the absence of the indication with the first signaling indicates that the measurement configuration should be applied. Alternatively, in another embodiment, the presence of the indication with the first signaling indicates that the measurement configuration should be applied, and the absence of the indication with the first signaling indicates that the measurement configuration should not be applied.

In the various methods described above, the first signaling may be dedicated to the UE. In the various methods described above, the first signaling may be a RRC connection reconfiguration message. In the various methods described above, the measurement configuration may include a MeasConfig (as disclosed in 3GPP TS 36.331 V11.3.0). In the various methods described above, the measurement configuration may include measuring a serving cell, intra-frequency cell, inter-frequency cell, or inter-RAT cell. The inter-RAT may be Universal Terrestrial Radio Access (UTRA), Code Division Multiple Access 2000 (CDMA2000), or GSM/EDGE Radio Access Network (GERAN). In the various methods described above, the measurement configuration includes reporting measurement results periodically or based on an event.

In another exemplary method, a UE camps on a cell. The UE receives a first signaling that includes a cell reselection configuration. The cell reselection configuration is applied by the UE upon the receipt of a second signaling indicating to start performing cell reselection evaluation. In another method, the UE stops applying the cell reselection configuration upon a third signaling indicating to stop performing cell reselection evaluation is received.

In another exemplary method, a network node sends a first signaling that includes a cell reselection configuration to a UE. The network node also sends a second signaling to indicate to the UE to apply the cell reselection configuration. In another method, a third signaling is sent to the UE to indicate to the UE to stop applying the cell reselection configuration.

In the various methods described above, the second signaling may be transmitted 6to multiple UEs, for example, by broadcast or multicast. In the various methods described above, the second signaling may be system information, a paging message, a PDCCH signaling, or a MAC control element. In the various methods described above, the second signaling does not affect other UE configurations. In the various methods described above, the second signaling includes a field, e.g., 1 bit, that is used as the indication for an action, e.g., start performing the measurement. In the various methods described above, the second signaling includes a time period for the indicated action, e.g., applying the measurement configuration for three minutes.

In another exemplary method, a UE camps on a cell. The UE receives a first signaling that includes a cell reselection configuration. The first signaling also includes an indication whether the cell reselection configuration should be applied by the UE. In one embodiment, the presence of the indication with the first signaling indicates that the cell reselection configuration should not be applied, and the absence of the indication with the first signaling indicates that the cell reselection configuration should be applied upon the reception of the first signaling. Alternatively, in another embodiment, the presence of the indication with the first signaling indicates that the cell reselection configuration should be applied upon the reception of the first signaling, and the absence of the indication with the first signaling indicates that the cell reselection configuration should not be applied.

In another exemplary method, a network node sends a signaling that includes cell reselection configuration and an indication to a UE. The indication is used to indicate to the UE to not apply the cell reselection configuration.

In another exemplary method, a UE camps on a cell. The UE acquires scheduling information for system information if the UE receives a paging message including a cell reselection notification. The UE acquires a first signaling that includes cell reselection configuration if the scheduling information indicates that the first signaling is present, wherein the paging message does not include a system information change notification.

In another exemplary method, a network node sends a paging message including a cell reselection notification to a UE to indicate to the UE to acquire a first signaling that includes a cell reselection configuration, wherein the paging message does not include a system information change notification.

In the various methods described above, the system information change notification is SystemInfoModification (as disclosed in 3GPP TS 36.331 V11.3.0), SystemInformationBlockType1 (as disclosed in 3GPP TS 36.331 V11.3.0), or SchedulingInfoList (as disclosed in 3GPP TS 36.331 V11.3.0). In the various methods described above, a value tag for system information, e.g., systemInfoValueTag (as disclosed in 3GPP TS 36.331 V11.3.0), is not changed due to a transmission of the paging message including the cell reselection notification. In the various methods described above, the first signaling may be system information. In the various methods described above, the cell reselection configuration may include SystemInformationBlockType3, SystemInformationBlockType4, SystemInformationBlockType5, SystemInformationBlockType6, SystemInformationBlockType7, or SystemInformationBlockType8 (as disclosed in 3GPP TS 36.331 V11.3.0). In the various methods described above, the cell reselection configuration includes measuring a cell the UE camps on, an intra-frequency cell, inter-frequency cell, or an inter-RAT frequency (e.g., UTRA, CDMA2000, or GERAN). In the various methods described above, the cell reselection configuration includes a threshold used to decide whether to reselect another cell. In the various methods described above, the UE is in RRC_IDLE (as disclosed in 3GPP TS 36.331 V11.3.0).

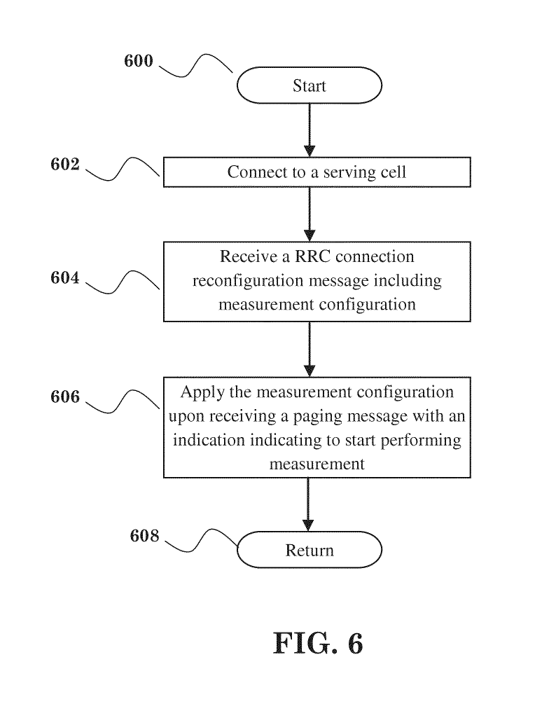

FIG. 6 illustrates a flow diagram of one exemplary method. The method includes the following steps: Step 600 Start; Step 602 Connect to serving cell; Step 604 Receive a RRC connection reconfiguration message including measurement configuration; Step 606 Apply the measurement configuration upon receiving a paging message with an indication indicating to start performing measurement; and Step 608 Return.

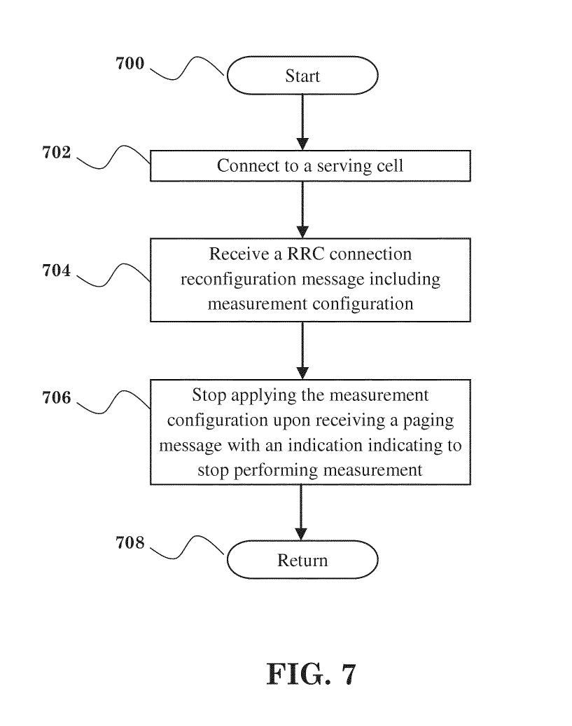

FIG. 7 illustrates a flow diagram of one exemplary method. The method includes the following steps: Step 700 Start; Step 702 Connect to serving cell; Step 704 Receive a RRC connection reconfiguration message including measurement configuration; Step 706 Stop applying the measurement configuration upon receiving a paging message with an indication indicating to stop performing measurement; and Step 708 Return.

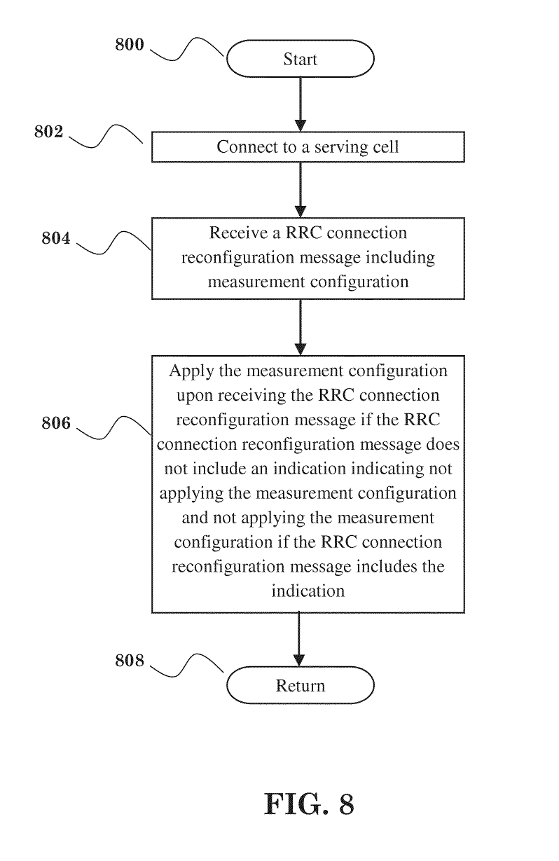

FIG. 8 illustrates a flow diagram of one exemplary method. The method includes the following steps: Step 800 Start; Step 802 Connect to serving cell; Step 804 Receive a RRC connection reconfiguration message including measurement configuration; Step 806 Apply the measurement configuration upon receiving the RRC connection reconfiguration message if the RRC connection reconfiguration message does not include an indication indicating not applying the measurement configuration and not applying the measurement configuration if the RRC configuration reconfiguration message includes the indication; and Step 808 Return.

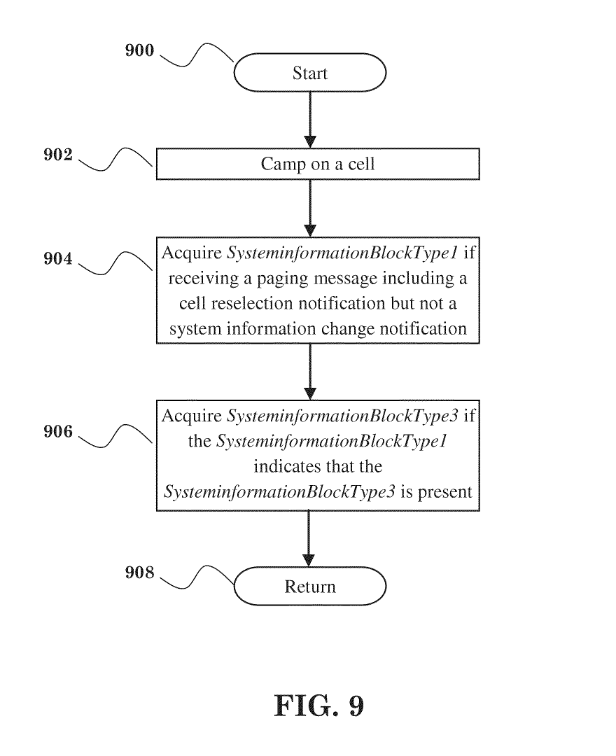

FIG. 9 illustrates a flow diagram of one exemplary method. The method includes the following steps: Step 900 Start; Step 902 Camp on a cell; Step 904 Acquire SystemInformationBlockType1 if receiving a paging message including a cell reselection notification but not a system information change notification; Step 906 Acquire SystemInformationBlockType3 if the SystemInformationBlockType1 indicates that the SystemInformationBlockType3 is present; and Step 908 Return.

Referring back to FIGS. 3 and 4, the device 300 includes a program code 312 stored in memory 310. In one embodiment, the CPU 308 could execute program code 312 to execute one or more of the following: (i) connecting to a serving cell; (ii) receiving a first signaling, wherein the first signaling includes a measurement configuration; (iii) applying the measurement configuration upon receiving a second signaling indicating to start performing the measurement configuration.

In addition, the CPU 308 can execute the program code 312 to perform all of the above-described actions and steps or others described herein.

With above methods or embodiments, unnecessary power consumption for measurement and/or cell reselection evaluation can be prevented efficiently.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for handling a configuration for measurement by a User Equipment (UE) in a wireless communication system, the method comprising:
connecting to a serving cell;
receiving a first signaling, wherein the first signaling includes a measurement configuration; and
applying the measurement configuration upon receiving a second signaling indicating to start performing measurement.

2. The method of claim 1, further comprising: stopping the application of the measurement configuration upon receiving a third signaling, wherein the third signaling indicates to stop performing the measurement.

3. The method of claim 1, wherein the UE does not leave Radio Resource Control Connected (RRC_CONNECTED) due to the second signaling.

4. The method of claim 1, wherein the first signaling is a Radio Resource Control (RRC) connection reconfiguration message.

5. The method of claim 1, wherein the measurement configuration includes MeasConfig or measuring a serving cell, intra-frequency cell, inter-frequency cell, or inter-RAT cell.

6. The method of claim 1, wherein the measurement configuration includes reporting measured results based on an event or reporting the measured results periodically.

7. The method of claim 1, wherein the second signaling is transmitting to multiple UEs.

8. The method of claim 1, wherein the second signaling is a paging message, Physical Downlink Control Channel (PDCCH) signaling, Medium Access Control (MAC) control element, or system information.

9. A method for handling a configuration for measurement by a User Equipment (UE) in a wireless communication system, the method comprising:
camping on a serving cell;
receiving a first signaling, wherein the first signaling includes a cell reselection configuration; and
applying the cell reselection configuration upon receiving a second signaling indicating to start performing cell reselection evaluation.

10. The method of claim 9, further comprising: stopping the application of the cell reselection configuration upon receiving a third signaling, wherein the third signaling indicates to stop performing the cell reselection evaluation.

11. The method of claim 9, wherein the second signaling is transmitting to multiple UEs.

12. The method of claim 9, wherein the second signaling is a paging message, Physical Downlink Control Channel (PDCCH) signaling, Medium Access Control (MAC) control element, or system information.

13. The method of claim 9, wherein the first signaling is system information.

14. The method of claim 9, wherein the cell reselection configuration includes SystemInformationBlockType3, SystemInformationBlockType4, SystemInfomationBlockType5, SystemInformationBlockType6, SystemInformationBlockType 7, or SystemInformationBlockType8.

15. The method of claim 9, wherein the cell reselection configuration includes measuring a cell the UE camps on, an intra-frequency cell, inter-frequency cell, or inter-RAT cell.

16. The method of claim 9, wherein the UE is in Radio Resource Control Idle (RRC_IDLE).

17. A communication device for handling a configuration for measurement in a wireless communication system, the communication device comprising:
a control circuit;
a processor installed in the control circuit;
a memory installed in the control circuit and operatively coupled to the processor;
wherein the processor is configured to execute a program code stored in memory to handle a configuration for measurement in the wireless communication system by:
connecting to a serving cell;
receiving a first signaling, wherein the first signaling includes a measurement configuration; and
applying the measurement configuration upon receiving a second signaling indicating to start performing measurement.

18. The communication device of claim 17, further comprising: stopping the application of the measurement configuration upon receiving a third signaling, wherein the third signaling indicates to stop performing the measurement.

19. The communication device of claim 17, wherein the first signaling is a Radio Resource Control (RRC) connection reconfiguration message.

20. The communication device of claim 17, wherein the second signaling is a paging message, Physical Downlink Control Channel (PDCCH) signaling, Medium Access Control (MAC) control element, or system information.
